(19) United States
(12) Patent Application Publication
(10) Pub. No.: US 2013/0144759 A1
(43) Pub. Date: Jun. 6, 2013

(54) PRODUCT PURCHASE DEVICE AND PRODUCT PURCHASE METHOD

(71) Applicant: Hitachi Consumer Electronics Co., Ltd., Tokyo (JP)

(72) Inventors: Takashi Toyomura, Yamato (JP); Naoki MORI, Yokohama (JP); Satoshi SANO, Fujisawa (JP); Mayumi NAKADE, Yokohama (JP)

(73) Assignee: Hitachi Consumer Electronics Co., Ltd., Tokyo (JP)

(21) Appl. No.: 13/682,525

(22) Filed: Nov. 20, 2012

(30) Foreign Application Priority Data
Nov. 21, 2011 (JP) 2011-253435

(51) Int. Cl. G06Q 30/06

(52) U.S. Cl. CPC G06Q 30/0629
USPC 705/26.64

(57) ABSTRACT

It is possible to prevent the erroneous purchase of products with similar appearance characteristics and descriptive information. In the present invention, similar products for which the product-related image information and text information is very similar are defined and the possibility of erroneous purchase is reported to the user at the time of product selection.

### INCORPORATION BY REFERENCE

The present application claims the priority of Japanese Patent Application Serial. No. JP2011-253435, filed on Nov. 21, 2011, the contents of which are incorporated herein by reference.

### BACKGROUND OF THE INVENTION

1. Field of the Invention

The invention is one pertaining to product purchases associated online mail-order sales using the Internet.

2. Description of the Related Art

In recent years, online mail-order sales have become brisk In online mail-order sales, the user cannot, as in a real store, pick up a genuine product in his hands and look at it, so he has no choice but to get a clue about the purchase from image information or text information about the product on a network online sale screen presented by the operator.

Accordingly, it is taken into consideration to present information to the user as appropriately as possible and, in JP-A-2001-265853, there is disclosed a technique of having related products defined and, on the occasion that the user has selected a certain product, presenting the related products.

Also, in JP-A-2009-251850, there is disclosed a technique of retrieving and presenting similar products on the occasion that the user has selected a certain product

### SUMMARY OF THE INVENTION

However, in the respective techniques of the aforementioned patent references, it is taken into consideration to efficiently display the product that the user is thought to want to buy, but on the contrary, it is not taken into consideration that he erroneously ends up purchasing a product for which the product-related image information or text information is very similar.

Accordingly, bearing in mind the aforementioned problem, there is set as an object to prevent the erroneous purchase of products for which information such as appearance, product name, or price, regarding product-related image information and text information, is very similar.

In order to attain the aforementioned object, in the present invention, there are defined similar products for which product-related image information and text information is very similar and, at the time product selection, the possibility of erroneous purchase is reported to the user. Specifically, the structure of the patent claims is adopted.

According to the present invention, it is possible to prevent the erroneous purchase of a similar product for which the product-related image information and text information is very similar.

Other objects, features, and advantages of the present invention will become apparent from the following description of embodiments of the present invention provided in relation to the accompanying drawings.

### BRIEF DESCRIPTION OF THE DRAWINGS

FIG. 1 is a diagram showing an example of the configuration of a product purchase device.

FIG. 2 is a diagram showing an example of the configuration of a connection between a product purchase device and a piece of equipment related to online mail-order sales.

FIG. 3 is a diagram showing an example of the configuration of an order server.

FIG. 4 is a diagram showing a procedure of carrying out a purchase with a product purchase device.

FIG. 5 is a diagram showing an example of a screen with which a user carries out browsing and selection of a product.

FIG. 6 is a diagram showing an example of a table managing order information.

FIG. 7 is a diagram showing an example of a table managing product information.

FIG. 8A is a diagram which shows a product image example.

FIG. 8B is a diagram which shows a product image example.

FIG. 8C is a diagram which shows a product image example.

FIG. 9 is a diagram showing a flowchart of a process of analyzing the degree of matching among products.

FIG. 10 is a diagram showing an example of table managing the degree of matching among products.

FIG. 11 is a diagram showing a flowchart of a process of analyzing the degree of matching among products and judging whether the same are similar.

FIG. 12 is a diagram showing an example of a table managing the threshold values judging whether or not the degree of matching among products is high.

FIG. 13 is a diagram showing an example of a table managing the combination of products with high similarity.

FIG. 14 is a diagram showing an example of a screen display calling attention to whether, with respect to the product selected by the user, there might not be an erroneous purchase of a similar product.

FIG. 15 is a diagram showing an example of a screen display calling attention to whether, with respect to the product selected by the user, there might not be an erroneous purchase of a similar product.

FIG. 16 is a diagram showing an example of a configuration of a product purchase device.

FIG. 17 is a diagram showing the flowchart of a process of judging whether there is a purchased product among those in a combination having high similarity and generating a similar products list on the basis of the order information.

FIG. 18 is a diagram showing an example of a table managing similar products based on the order information.

FIG. 19 is a diagram showing an example of the configuration of a product purchase device.

FIG. 20 is a diagram showing the flowchart of a process of judging whether there exists a product, among those in a combination having high similarity, that has been cancelled and generating a similar products list on the basis of the operation history.

FIG. 21 is a diagram showing an example of a table managing products that have once been registered as candidates for purchase but which did not reach final purchase.

FIG. 22 is a diagram showing an example of a table managing similar products based on the operation history.

FIG. 23 is a diagram showing an example of the configuration of an order server.

FIG. 24 is a diagram showing an example of a screen display eliciting, with respect to the operator, an improvement in the display method regarding similar products.

### DESCRIPTION OF THE EMBODIMENT

Hereinafter, the embodiments be described using the drawings.

### 1. The First Embodiment

In the present embodiment, there is shown an example of defining in advance products for which product-related image information and product-related text information is similar and, in the case where there are similar products with respect to the product selected by the user, displaying a message calling attention to the user

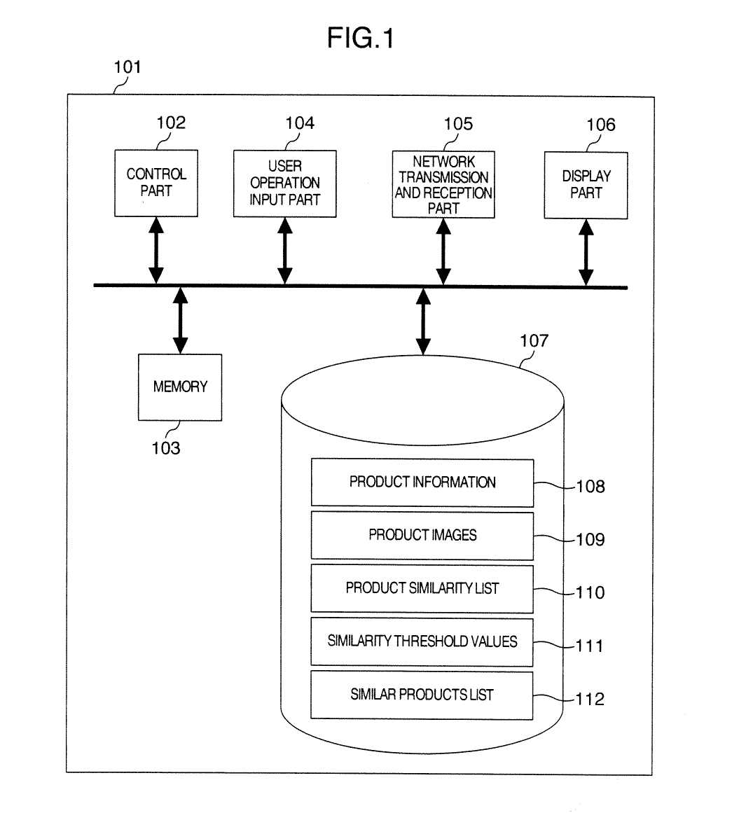

FIG. 1 is a diagram showing an example of the configuration of a product purchase device relating to the present embodiment. A product purchase device 101 comprises: a user operation input part 104 receiving instructions from the user, such as mouse operation and touch panel operation; a network transmission and reception 105 carrying out transmission and reception of data via a network; a display part 106 presenting screens to the user; a data accumulation part 107 accumulating and saving product information 108 managing text information related to the product presented to the user as well as product images 109 managing image information about the product presented to the user, a product similarity list 110 managing the degrees of matching of product images and product information with respect to the combination of products, similarity threshold values 111 serving as reference for whether the degrees of matching are high or not, and a similar products list 112 managing combinations of products for which the similarity, determined by the degree of matching between product images or pieces of product information, is high; a control part 102 operationally controlling user operation input part 104, network transmission and reception part 105, display part 106, and data accumulation part 107: and a memory 103 being a storage part temporarily holding processing data related to the operational control in control part 102; and is configured by having each of the parts connected by means of a common bus (including a data bus and an address bus).

As a part hereof, control part 102, together with analyzing the similarity of the product characteristics from product information 108 and product images 109 of data accumulation part 107, saving the same as product similarity list 110 in data accumulation part 107, analyzing the combinations of products with high similarity from product similarity list 110 and similarity threshold values 111 of data accumulation part 107, and saving the same as similar products list 112 in data accumulation part 107, has a function of displaying a message calling attention to whether there might not be an erroneous purchase on the display screen of display part 106, in the case where the product selected by the user with user operation input part 104 exists in similar products list 112 of data accumulation part 107.

Also, control part 102, on the occasion that the user utilizes online mail-order sales, presents the product information acquired by network transmission and reception part 105 on the display screen of display part 106 and receives product selection operation through a mouse or a touch panel from user operation input part 104. Product information 108 and product images 109 of data accumulation part 107 are pieces of information that are received via network transmission and reception part 105 and saved, similarity threshold values 111 being information saved in advance. Product similarity list 110 and similar products list 112 are pieces of information computed in control part 102 using product information 108 and product images 109.

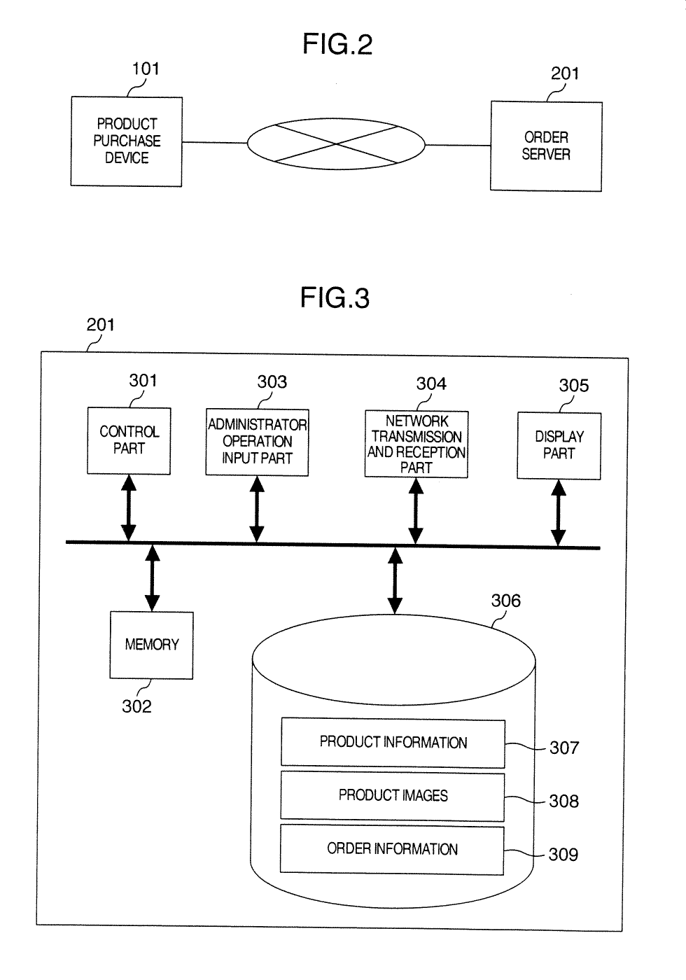

FIG. 2 is a diagram showing an example of the configuration of connection between product purchase device 101 relating to the present embodiment and equipment related to online mail-order sales. Order server 201 is a server managed by an operator carrying out online mail-order sales and is connected with product purchase server 101 by means of a network such as the Internet.

Product purchase device 101 is a device serving as an interface utilized by a user for online mail-order sales. The user manipulates product purchase device 101 to browse and select a product. Product purchase device 101 is connected with order server 201 by means of a network and performs operations like downloading product information and uploading order information. Order server 201 manages products and transmits product information in response to requests from product purchase device 101. Also, order server 201 receives and manages order information from product purchase device 101.

FIG. 3 is a diagram showing an example of an internal configuration of an order server 201 relating to the present embodiment. Order server 201 comprises: an administrator operation input part 303 receiving instructions from an administrator, such as mouse operations and touch panel operations; a network transmission and reception part 304 carrying out transmission and reception of data via the network; a display part 305 presenting a screen to the administrator; a data accumulation part 306 accumulating and saving: product information 307 managing products handled by the online mail-order sales as well as product images 308 and order information 309 managing orders from the user; a control part 301 operationally controlling administrator operation input part 303, network transmission and reception part 304, display part 305, and data accumulation part 306; and a memory 302 being a storage part temporarily holding processing data related to operational control in control part 301; and is configured by having each of the parts connected by means of a common bus (including a data bus and an address bus). Product information 307 in data accumulation part 306 is transmitted in response to a request from product purchase device 101 via network transmission and reception part 304. Order information 309 is received from product purchase device 101 via network transmission and reception part 304 and is saved in data accumulation part 306. Also, on the occasion that the administrator of order server 201 carries out management operations, management operations through mouse operations and touch panel operations are received from administrator operation input part 303 and the result of the processing is presented in display part 305. It is possible for the administrator to browse the content of product information 307, product images 308, and order information 309 saved in data accumulation part 306 by means of display part 305.

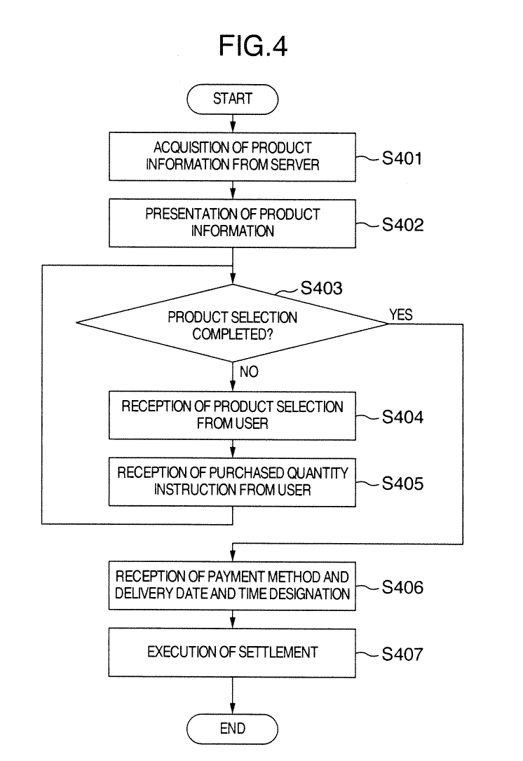

FIG. 4 is a diagram showing the procedure of carrying out purchases with product purchase device 101 relating to the present embodiment. A description will be given from the stage of switching on the power supply of product purchase device 101 and starting a purchase.

Step S401 is a step of acquiring the latest product information from order server 201. A request is sent from product purchase device 101 to order server 201 and product information gradually transmitted from order server 201 is received.

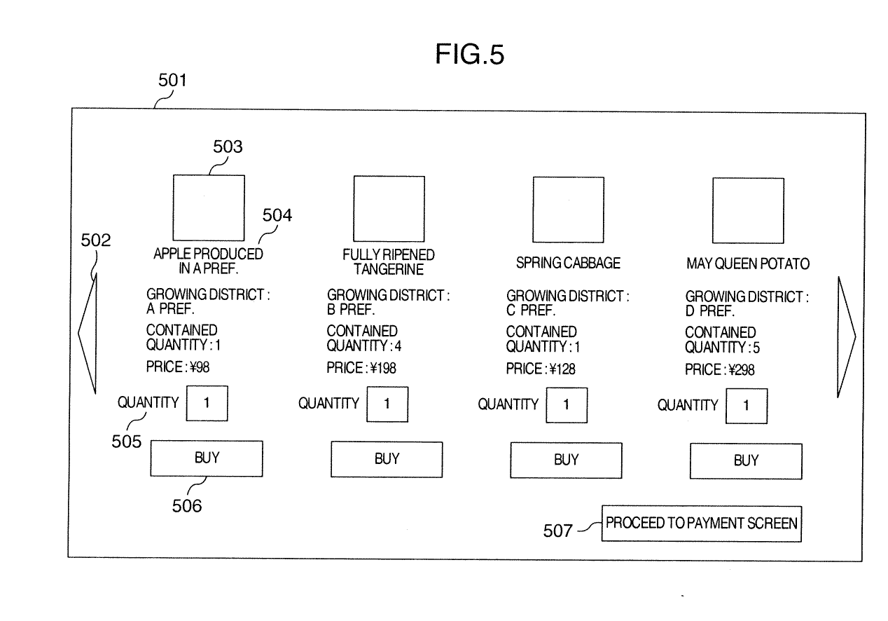

Step S402 is a step of presenting product information on display part 106 of product purchase device 101. The product information acquired in Step S401 is converted into a format that can be displayed on display part 106 and is presented to the user. The user manipulates the presented screen, browses products, and selects a product. An example of a screen presented to the user is shown in FIG. 5.

Screen 501 is an area of the screen presented in display part 106 by product purchase device 101. The product information is displayed by combining product images 503 and product details 504. In product details 504, there is included text information such as product name, growing district, contained quantity, and price. The user inputs the quantity of the product to be purchased in a quantity instruction field 505 and, by selecting a purchase decision button 506, registers the product as a candidate for purchase. Also, it is possible to perform operations like switching over the screen to an adjacent page to browse other products by selecting a scroll-down button 502 and, by selecting a payment screen transition button 507, defining a purchase candidate product and moving to a settlement-making screen.

Step S403 is a step of determining whether or not there was a user input showing that the product selection has reached completion. E.g., it is detected that the user has pushed payment screen transition button 507. In case there has been user input showing that product selection has reached completion, the process proceeds to Step S406 and, in case there is none, to Step S404.

Step S404 is a step of receiving the input of a product selection due to the user.

After the input has been received, the process proceeds to Step S405.

Step S405 is a step of receiving a purchased quantity instruction regarding the product selected in Step S404. After the instruction has been received, the process returns to Step S403 and determines for a second time whether or not there is a user input showing that product selection has reached completion.

Step S406 is a step of receiving information for payment from the user. There are received payment method instructions such as cash on delivery or by credit card, instructions on the desired delivery date and time, and the like. After the instructions have been received, the process proceeds to Step S407.

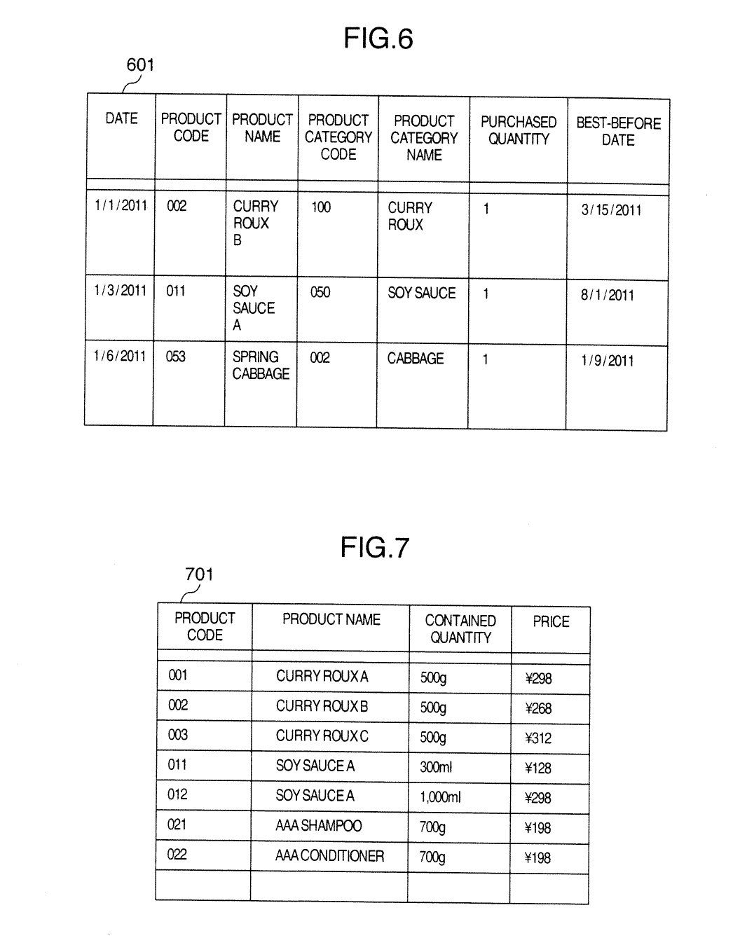

Step S407 is a step of defining a purchase candidate product by means of user input. After displaying the payment method, the desired delivery day and date, et cetera, and eliciting a confirmation from the user, the order is established by means of user input. The established order information is transmitted to order server 201 from product purchase device 101 and is saved in data accumulation part 306. The accumulated order information is used for analysis of user purchasing movements and the like An example of a table managing order information is shown in FIG. 6.

Order information table 601 comprises dates, product codes, product names, product category codes, product category names, purchased quantities, best-before dates, and the like. On the occasion that product purchase device 101 carries out processing, products are managed by purchase date by means of product codes for identifying products and product names for presentation to the user. Also, in order to handle similar products in a consolidated way, there are given product category codes and product category names that express the category with which a product is affiliated. As information attached to the purchased products, purchased quantities and best-before dates are associated and saved.

Hereinafter, there will be given a description of a procedure of analyzing the similarity among products and, in the case where there are products that have high similarity with respect to the product selected by the user, preventing an erroneous purchase.

FIG. 7 is an example of a table managing product information in data accumulation part 107. Product information table 701 comprises product codes, product names, contained quantities, and prices. Products are managed by means of product codes for identifying products by product purchase device 101 and product names for presentation to the user. Also, as information attached to the products, contained quantities and prices are associated and held

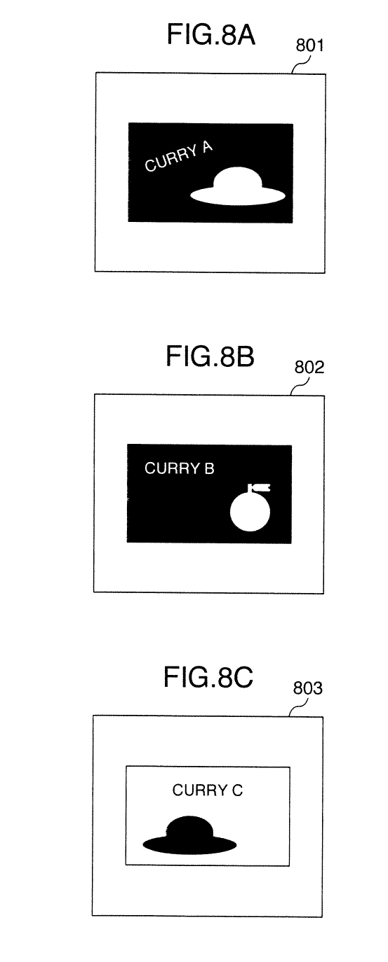

FIGS. 8A, 8B, and 8C are examples of product images managed in data accumulation part 107. Product image 801 is the image of product codes, product image 802 is the image of product code “002”, and product image 803 is the image of product code “003”. These product images are images for presentation by product purchase device 101 on a display screen by means of display part 106, the product package photographs and images illustrating the products being registered by the operator.

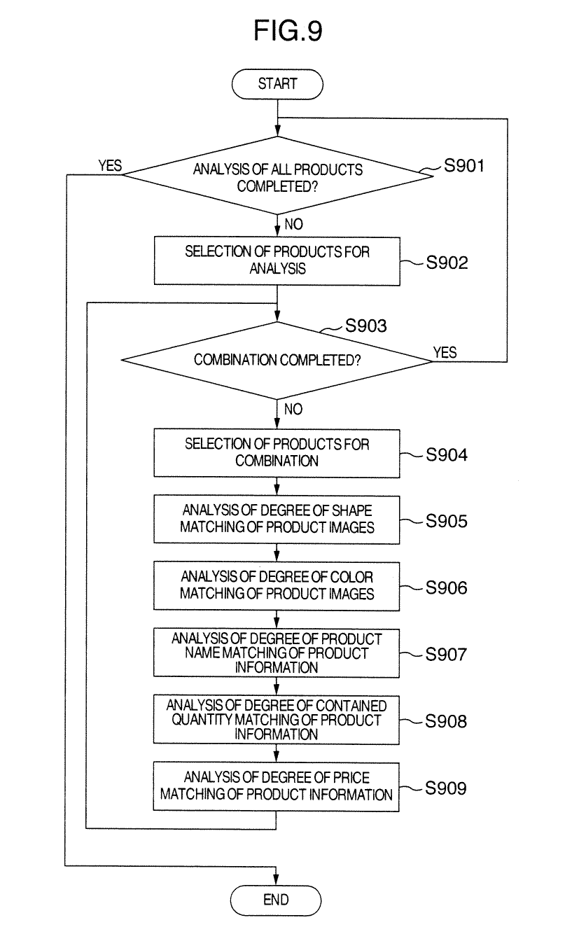

In FIG. 9, there is shown a flowchart of the process of analyzing the degree of matching among the products.

Step S901 is a step of determining whether or not a matching analysis process based on combinations regarding all the products has reached completion. In the case where completion has not been reached, the process proceeds to Step S902 and continues the analysis. In the case where completion has been reached, the process of analyzing the degree of matching among the products in the present embodiment is terminated.

Step S902 is a step of selecting the products subject to being analyzed for degree of matching. Arbitrary products are selected from among the products registered in product information table 701.

Step S903 is a step of determining whether the combination implementation has reached completion for all products subject to combination with respect to the products selected in Step S902. In case completion has not been reached, the process proceeds to Step S904 to continue the analysis. In case completion has been reached, the process proceeds to Step S901 and carries out a determination of analysis completion.

Step S904 is a step of selecting the combination products with respect to the products selected in Step S902. From among the products registered in product information table 701, an arbitrary one is selected from among the products not subject to analysis.

Step S905 is a step of analyzing the degree of shape matching of the mutual product images, regarding the combination of the products selected in Step S902 and the product selected in Step S904 By means of image recognition processing, the mutual characteristic points of the product images are extracted and compared and it is evaluated to which extent they match. E.g., in the case of analyzing the degree of matching of the shapes of the product images of product code “001” and product code “002”, there is given a high numerical value as the degree of matching, due to the fact that all external package shapes are rectangular.

Step S906 is a step of analyzing the degree of matching of the colors of the mutual product images, regarding the combination of the products selected in Step S902 and the product selected in Step S904. By means of image recognition processing, the fractions of colors accounted for in the mutual product images are computed and it is evaluated to which extent they match. E.g., in the case of analyzing the degree of matching of the product images of product code “001” and product code “002”, there is given a high numerical value as the degree of matching, due to the fact that the fractions accounted for by painting over the same colors are of the same extent. Also, in the case of analyzing the degree of matching of the product images of product code “001” and product code “003”, there is given a low numerical value as the degree of matching since colors accounting for more than half of the images are different.

Step S907 is a step of analyzing the degree of matching the product names of the mutual product information, regarding the combination of the product selected in Step S902 and the product selected in Step S904. By means of text processing, the mutual product names are compared as character strings and it is evaluated to which extent they match. E.g., in the case of analyzing the degree of matching of the product names of product code “011” and product code “012”, there is given a high numerical value as the degree of matching, due to the fact that the product names are identically the same. Also, in the case of analyzing the degree of matching of the product names of product code “021” and product code “022”, the first halves of the product names match completely, but since the second halves do not match at all, a moderate-level value is given as the degree of matching.

Step S908 is a step of analyzing the degree of matching of contained quantities in the mutual product information, regarding the combination of the products selected in Step S902 and the product selected in Step S904. From numerical value processing, the mutual contained quantities are compared as numerical values and it is evaluated to which extent they match. E.g., in the case of analyzing the degree of matching of the contained quantities of product code “011” and product code “012”, there is given a low value as the degree of matching, due to the fact that there is a disparity on the order of three times in the contained quantities. Also, in the case of analyzing the degree of matching of the contained quantities of product code “021” and product code “022”, there is given a high value as the degree of matching, due to the fact that the contained quantities are the same.

Step S909 is a step of analyzing the degree of matching of the prices of the mutual product information, regarding the combination of products selected in Step S902 and the product selected in Step S904. From numerical value processing, the mutual prices are compared as numerical values and it is evaluated to which extent they match. E.g., in the case of analyzing the degree of matching of the prices of product code “011” and product code “012”, there is given a low value as the degree of matching, due to the fact that there is a disparity of more than two times in the price. Also, in the case of analyzing the degree of matching of the price of product code “021” and product code “022”, there is given a high value as the degree of matching, due to the fact that the prices are the same.

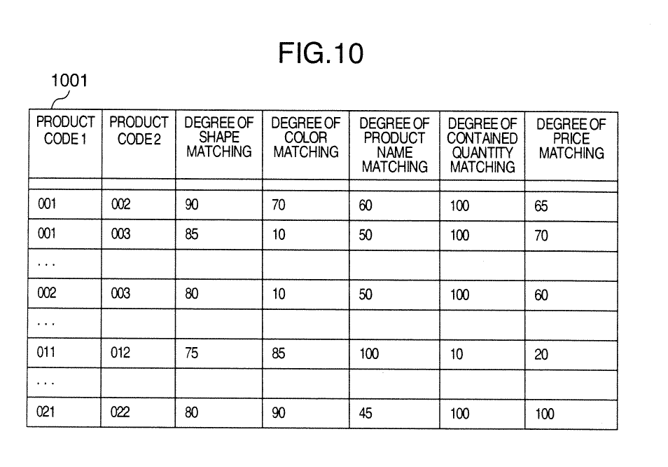

The numerical values of the degrees of matching given from Steps S905 up to S909 are managed in a table such as FIG. 10, FIG. 10 is an example of a table managing the degrees of matching of each of the determined aspects, with respect to the combination of products. The table 1001 of FIG. 10 is saved as a product similarity list of data accumulation part 107. Regarding two products determined by product codes, the degrees of matching of the shapes, the colors, the product names, the contained quantities, and the prices are converted into numerical values with 100 as the maximum and stored.

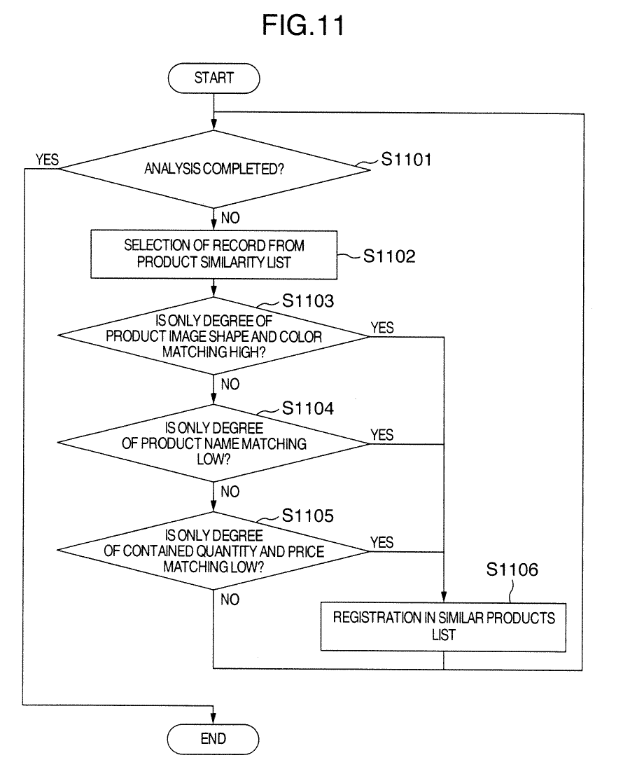

In FIG. 11, there is shown a flowchart of a process of retrieving combinations of products for which it can be judged from the product similarity list that the similarity is high and generating a similar products list.

Step S1101 is a step of determining whether the process of analyzing the product similarity list has reached completion. In the case where completion has not been reached, the process proceeds to Step S1102. In the case where completion has been reached, the step of generating the similar products list is terminated.

Step S1102 is a step of selecting an arbitrary record from the product similarity list. With the selected record, the process proceeds to Step S1103.

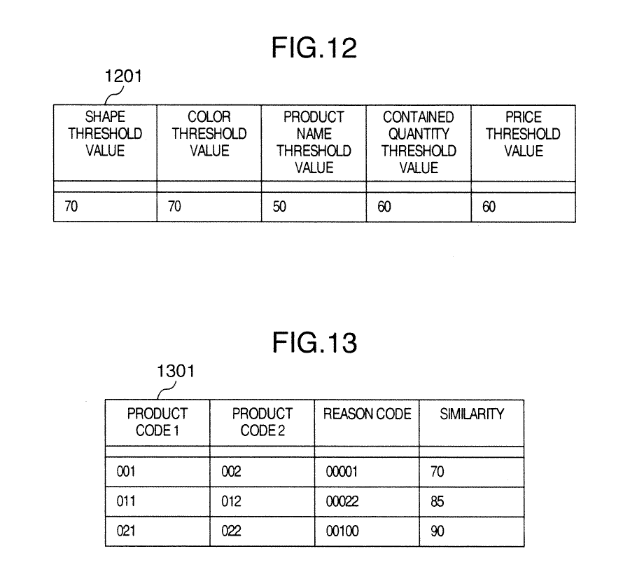

Step S1103 is a step of determining, regarding the record selected in Step S1102, whether the degrees of matching of only the shapes and the colors of the product images are high. Whether or not the degrees of matching are high is judged on the grounds of similarity threshold values 111 in data accumulation part 107. Similarity threshold values 111 are managed in a table 1201 such as shown in FIG. 12, managing the respective threshold values of shape, color, product name, contained quantity, and price. In the case where the degrees of matching of the shapes and colors of the product images are higher than the threshold values and the degrees of matching of the product names, the contained quantities, and the prices are lower than the threshold values, the process proceeds to Step S1106. In cases other than that, the process proceeds to Step S1104.

Step S1104 is a step of determining whether the degree of matching of the product names only is low, regarding the record selected in Step S1102. In the case where the degree of matching of the product names is lower than the threshold value and the degrees of matching of the shapes and colors of the product images, as well as of the contained quantities and prices, are higher than the threshold values, the process proceeds to Step S1106. In cases other than that, the process proceeds to Step S1105.

Step S1105 is a step of determining whether the degrees of matching of the contained quantities and prices are high, regarding the record selected in Step S1102. In the case where the degrees of matching of the contained quantities and the prices are lower than the threshold values and the degrees of matching of the shapes and colors of the product images, and of the product names, are higher than the threshold values, the process proceeds to Step S1106. In cases other than that, the process returns to Step S1101 and continues the analysis of the product similarity list.

Step S1106 is a step of registering, in the case where the degrees of matching related to the aspects in Steps S1103, S1104, or S1105 meet the conditions, the combination of the same products as similar products in a similar products list. An example of a similar products list is shown in FIG. 13.

Similar products list 1301 has the fields product code 1, product code 2, reason code, and similarity. In product code 1 and product code 2, there are stored two product codes of a combination determined to have high similarity. In the reason code, there is coded and stored the reason why the similarity regarding this combination was determined to be high. E.g., in the case where it has come about that, due to the fact that only the degrees of matching of the shapes and colors of the product images have been determined in Step S1103 to be high, there was a registration in the similar products list, the determination reason therefor being stored as a code “00001”. In the similarity, the strength of the similarity of this combination is converted into a numerical value and stored. After the step of Step S1106, the process returns to Step S1101 and continues the analysis of the product similarity list.

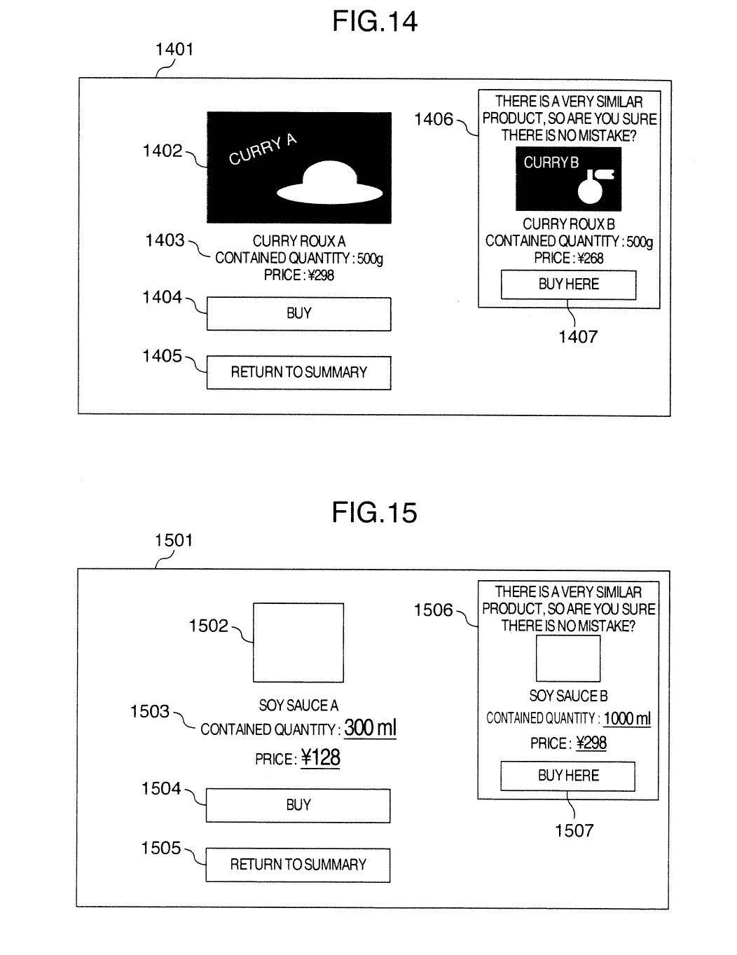

There will be given a description regarding the process of displaying, on the occasion that the user selects a product, a message to arouse attention as to whether there might not be an erroneous purchase in case there are similar products. On the occasion that the user selects a product, it is confirmed whether or not the selected product is present in the similar products list. In the case where the product code of the product selected by the user matches one product code stored in product code 1 or product code 2 of the similar products list, the product with the other product code in the combination thereof is determined to be a similar product. E.g., in the case where the product code of the product selected by the user matches a product code 1 of a record present in the similar products list, the product code stored in product code 2 of the same record is a similar product. In the case where there exists a similar product with respect to the product selected by the user, e.g. as shown in FIG. 14, it is reported that there is a similar product with respect to the product selected by the user and a check as to whether there is not any erroneous purchase is elicited. It is also acceptable to display the reason for registration in the similar products list.

In the present embodiment, a description was given with an example in which only product with high similarity is registered in the similar products list, but in the case where multiple ones are registered, it is acceptable to display all on the screen. Also, it is acceptable to display only the high-priority items, from the highest rank, on the basis of the similarities of the similar products list.

Screen 1401 is a screen area presented by product purchase device 101 on a display screen of display part 106. Information about a product selected by the user is presented as a combination of a product image 1402 and product information details 1403. By selecting a purchase button 1404, the user is able to register the currently presented product as a candidate for purchase. Also, by selecting a return button 1405, he can return to the product summary screen. Here, similar products information 1406 is an area presenting information about a product that has been determined, from the process of FIG. 11, to have high similarity. Together with showing a product image and product information details about the similar product, it elicits, by means of a message, a check as to whether there is no erroneous purchase. If it is the case that the user has selected an erroneous product and the product that he really wanted to purchase is the similar product, he is able, by selecting a similar product purchase button 1407, to correct the purchase selection and register the product corresponding to the intent of the user as a candidate for purchase.

Also, the presentation to the user may be displayed as shown in FIG. 15. Screen 1501 is a screen area that is presented by product purchase device 101 on the display screen of display part 106. Information about the product selected by the user is presented with a combination of a product image 1502 and product information details 1503. By selecting a purchase button 1504, the user can register the product that is currently presented as a candidate for purchase. In addition, by selecting a return button 1505, he can return to a product summary screen. Here, similar product information 1506 is an area presenting information about a product that is determined, by means of the process of FIG. 11, to have high similarity. Together with showing a product image and product information details about the similar product, it elicits, by means of a message, a check as to whether there is no erroneous purchase. At this point, it is acceptable to mutually highlight the differing portions product name, contained quantity, and price so as to make the differences of the similar product easy to recognize for the user. If it is the case that the user has selected an erroneous product and the product that he really wanted to purchase is the similar product, he is able, by selecting a similar product purchase button 1507, to correct the purchase selection and register the product corresponding to the intent of the user as a candidate for purchase.

By means of the processes of the present embodiment there is presented the fact that there are similar products, with respect to the product selected by the user, and by eliciting a check, it is possible to prevent an erroneous purchase.

### 2. Second Embodiment

In Embodiment 1, there was shown an example of determining similarity on the basis of product images and product information and carrying out attention arousal toward the user, but it is acceptable, in the case where the user often purchases a similar product, with respect to the product selected by the user, to judge, on the basis of user order information, that the currently selected product has a high probability of being an erroneous purchase.

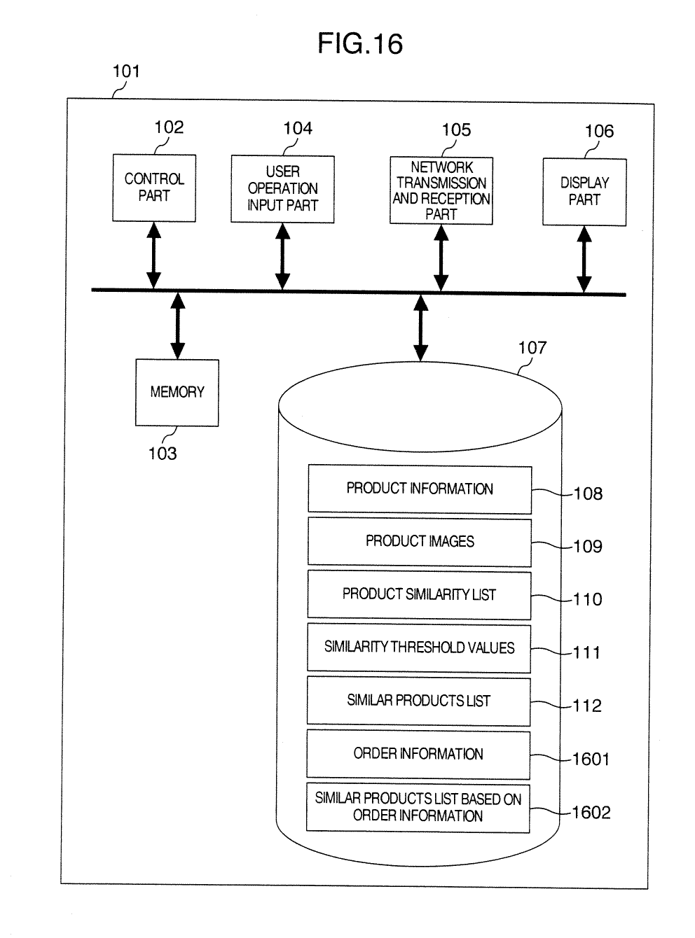

FIG. 16 is a diagram showing an example of a configuration of a product purchase device relating to the present embodiment. In data accumulation part 107 of product purchase device 101, order information 1601 managing the history of products purchased by the user as well as a similar products list (based on order information) 1602 in which there are defined combinations of products having high similarity based on the order information of the user are accumulated and saved. As for order information 1601, purchased products instructed via user operation input part 104 may be stored successively, or may, as the need arises, be received from order server 201 via network transmission and reception part 105 and saved. The similar products list (based on order information) 1602 is one that is computed in control part 102 using similar products list 112 and order information 1601.

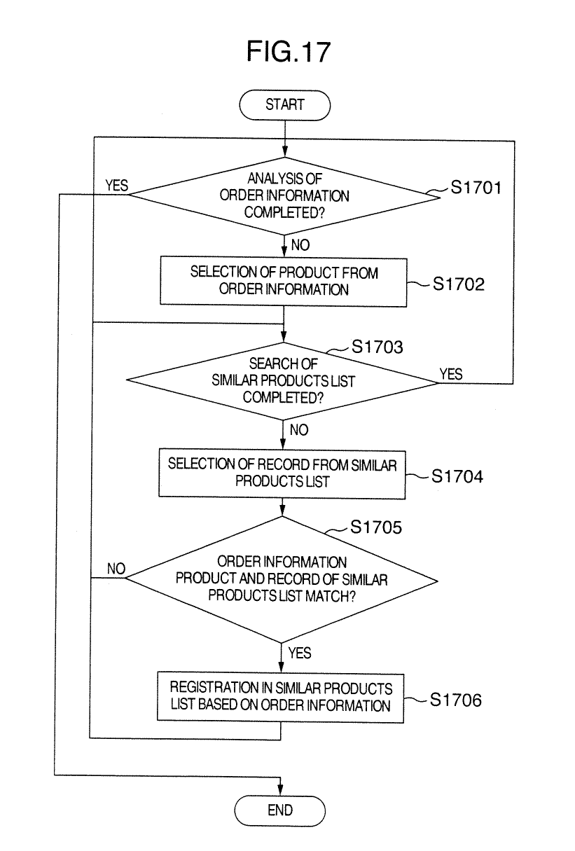

FIG. 17 is a flowchart of a process of generating a similar products list based on order information, on the basis of the similar products list generated in Embodiment 1 and order information 1601.

Step S1701 is a step of determining whether or not the product selection from the order information has reached completion. If completion has not been reached, the process proceeds to Step S1702. In case completion has been reached, the process of generating the similar products list based on order information, which is associated with the present embodiment is terminated.

Step S1702 is a step of extracting an arbitrary purchased product from the order information. With the extracted product, the process proceeds to Step S1703.

Step S1703 is a step of determining whether the search of the similar products list has reached completion. In case completion has not been reached, the process proceeds to Step S1704. In case completion has been reached, the process returns to Step S1701 and carries out a determination of the completion of the order information analysis.

Step S1704 is a step of selecting an arbitrary record from the similar products list. With the selected record, the process proceeds to Step S1705.

Step S1705 is a step of determining whether or not the product selected in Step S1702 is included in the record selected in Step S1704. It is determined whether or not product code 1 or product code 2, of the similar products list, matches the product code of the product selected in Step S1702. In the case of matching, the process proceeds to Step S1706. In the case of no matching, the process returns to Step S1703 and there is carried out a determination that the search has reached completion.

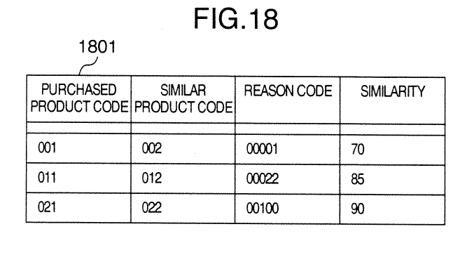

Step S1706 is a step of registering the similar products list record including the product selected in Step S1702 in the similar products list based on order information. FIG. 18 is an example of a similar products list based on order information. The similar products list (based on order information) 1801 has the fields purchased product code, similar product code, reason code, and similarity. From among the similar products list records to be registered, the product code of the product selected in Step S1702 is stored in the purchased product code field and the other product codes are stored in the similar product code field. E.g., in the case where product code 1 of the record of the similar products list matches the product code selected in Step S1702, product code 1 is stored in the purchased product code field and product code 2 is stored in the similar product code field. After this step, the process returns to Step S1701 and there is carried out a determination that the order information analysis has reached completion.

By carrying out the aforementioned steps, it is possible to generate a similar products list based on order information. On the occasion that the user selects a product, it is determined whether or not a selected product is present in the similar product code field of the similar products list based on order information and in case it is present, the purchased product code of the same record is reported as a similar product to the user by means of a display method shown in FIG. 14 or FIG. 15.

In the present embodiment, the system was devised so that it is reported to the user if a product that has been purchased if only once is present as a similar product, but it does not matter if the system is devised so that it is reported to the user only in the case where the totalized number of purchases exceeds a certain threshold value.

### 3. Third Embodiment

In Embodiment 2, it was judged, on the basis of user order information, that the currently selected product had a high probability of being an erroneous purchase in the case where the user often purchased a similar product, with respect to the product selected by the user, and there was carried out attention arousal toward the user, but it is acceptable to in particular carry out attention arousal toward the user regarding a product that, based on the operation history of the user, he has begun to purchase erroneously.

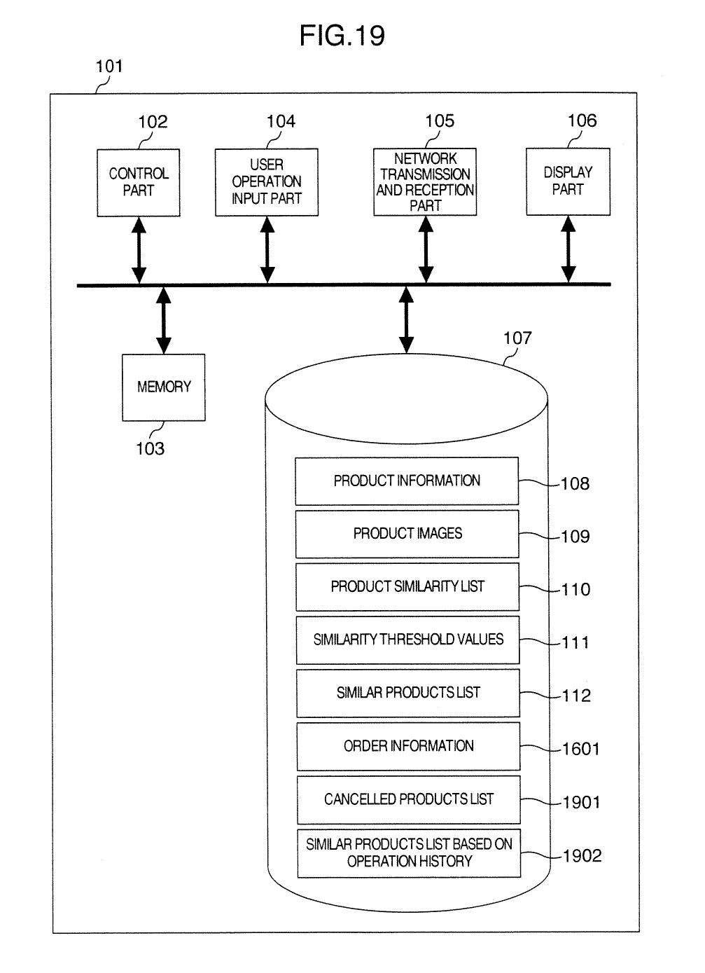

FIG. 19 is a diagram showing an example of a configuration of a product purchase device relating to the present embodiment. In data accumulation part 107 of product purchase device 101, there are accumulated and saved a cancelled product list 1901 managing products that the user once registered as candidates for purchase but which did not reach final purchase as well as a similar products list (based on operation history) 1902 in which there are defined combinations of products with high similarity on the basis of the operation history of the user. As for cancelled products list 1901, products instructed to be registered as candidates for purchase via user operation input part 104 are stored successively and are left accumulated with the exception of products that were finally ordered The similar products list (based on operation history) 1902 is one that is computed in control part 102 using similar products list 112 and cancelled products list 1901.

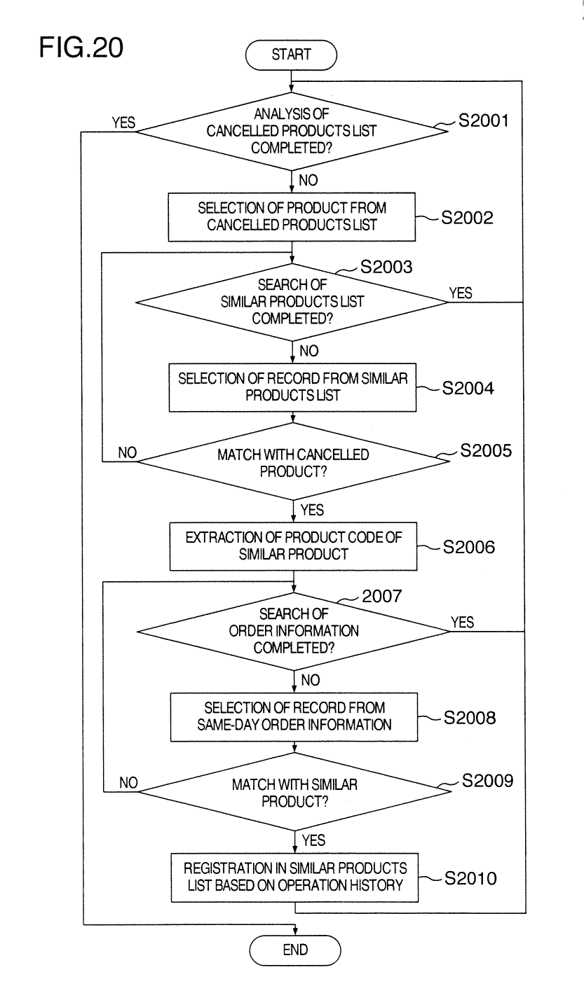

FIG. 20 is a flowchart of a process generating a similar products list based on the operation history, on the basis of the similar products list generated in Embodiment 1 and cancelled products list 1901.

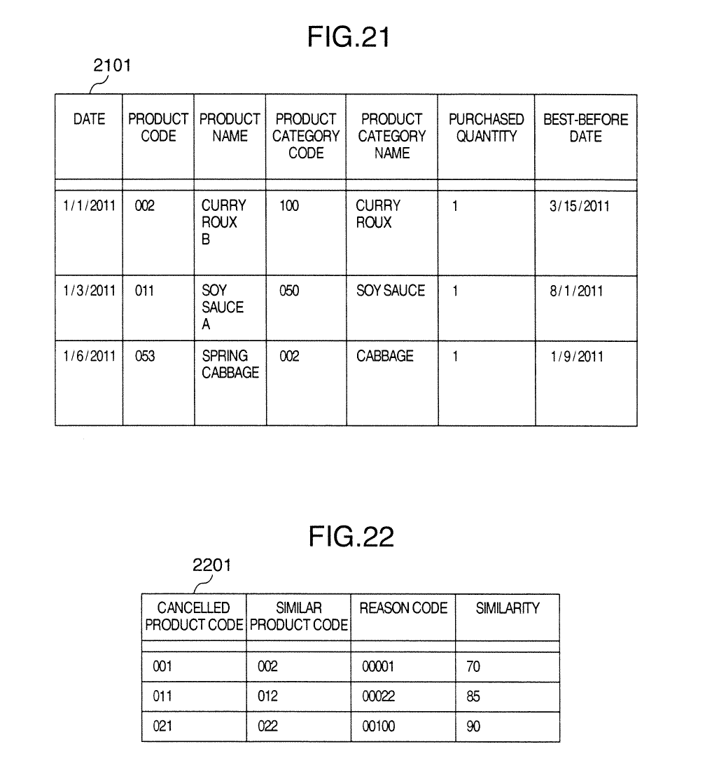

Step S2001 is a step of determining whether or not the product selection from the cancelled products list has reached completion. If completion has not been reached, the process proceeds to Step S2002. In case completion has been reached, the generation step of the similar products list, based on operation history, associated with the present embodiment is terminated. FIG. 21 is an example of a cancelled products list. Cancelled products list 2101 e.g. has same fields as the order information and only products that have been cancelled during final ordering even though the products had once been registered as candidates for purchase are registered therein.

Step S2002 is a step of extracting an arbitrary product from the cancelled products list. With the cancelled product, the process proceeds to Step S2003

Step S2003 is a step of determining whether or not the search of the similar products list has reached completion. In case completion has not been reached, the process proceeds to Step S2004. In case completion has been reached, the process returns to Step S2001 and carries out a determination of the completion of the cancelled products list.

Step S2004 is a step of selecting an arbitrary record from the similar products list. With the selected record, the process proceeds to Step S2005.

Step S2005 is a step of determining whether or not the product selected in Step S2002 is included in the record selected in Step S2004. It is determined whether or not product code I or product code 2 of the similar products list matches the product code of the product selected in Step S2002. In the case of matching, the process proceeds to Step S2006. In the case of no matching, the process returns to Step S2003 and there is carried out a determination that the search has reached completion.

Step S2006 is a step of extracting a product code that rather did not match in Step S2005. E.g., in the case where the product selected in Step S2002 matches product code 1 of the record selected in Step S2004, product code 2 of the same record is extracted. With the extracted product code, the process proceeds to Step S2007.

Step S2007 is a step of determining whether or not the search of the order information has reached completion. In case completion has not been reached, the process proceeds to Step S2008. In case completion has been reached, the process returns to Step S2001 and there is carried out a determination of completion of the analysis of the cancelled products list.

Step S2008 is a step of selecting a record from the same date as the registration date of the product that was selected in Step S2002 from the order information With the selected record, the process proceeds to Step S2009.

Step S2009 is a step of determining whether or not the product code extracted in Step S2006 matches the product code of the record selected in Step S2008. In the case of matching, the process proceeds to Step S2010. In the case of no matching, the process returns to Step S2007 and there is carried out a determination of completion of the order information search.

Step S2010 is a step of registering, in the similar products list based on operation history, the similar products list record including the product selected in Step S2006. FIG. 22 is an example of a similar products list based on operation history. The similar products list (based on operation history) 2201 has the fields cancelled product code, similar product code, reason code, and similarity. The product code of the product selected in Step S2002, from among the similar products list records to be registered, is stored in the cancelled product code field and the other product code is stored in the similar product code field. E.g., in the case where product code 1 of the similar products list record matches the product code selected in Step S2002, product code 1 is stored in the cancelled products code field and product code 2 is stored in the similar products code field. After this step, the process returns to Step S2001 and there is carried out a determination of completion of the analysis of the cancelled products list.

By carrying out the aforementioned processes, it is possible to generate a similar products list based on operation history. On the occasion that the user selects a product, it is determined whether or not the selected product is present in the cancelled product code field of the similar products list based on operation history and in case it is present, the similar product code of the same record is reported to the user as a similar product by means of a display method shown in FIG. 14 or FIG. 15.

In the present embodiment, if it has occurred that a selected product has been cancelled if only once, it was reported to the user, but it does not matter if the system is devised so that it is reported to the user only in the case where the totalized number of cancellations exceeds a certain threshold value.

### 4. Fourth Embodiment

In Embodiment 1, Embodiment 2, and Embodiment 3, there were shown examples of carrying out, on the occasion that the user selects a product, an attention arousal with respect to the user as to whether or not there might not be an erroneous purchase, if a similar product is present, but it is acceptable to elicit a display method improvement by reporting to the operator that a similar product is present.

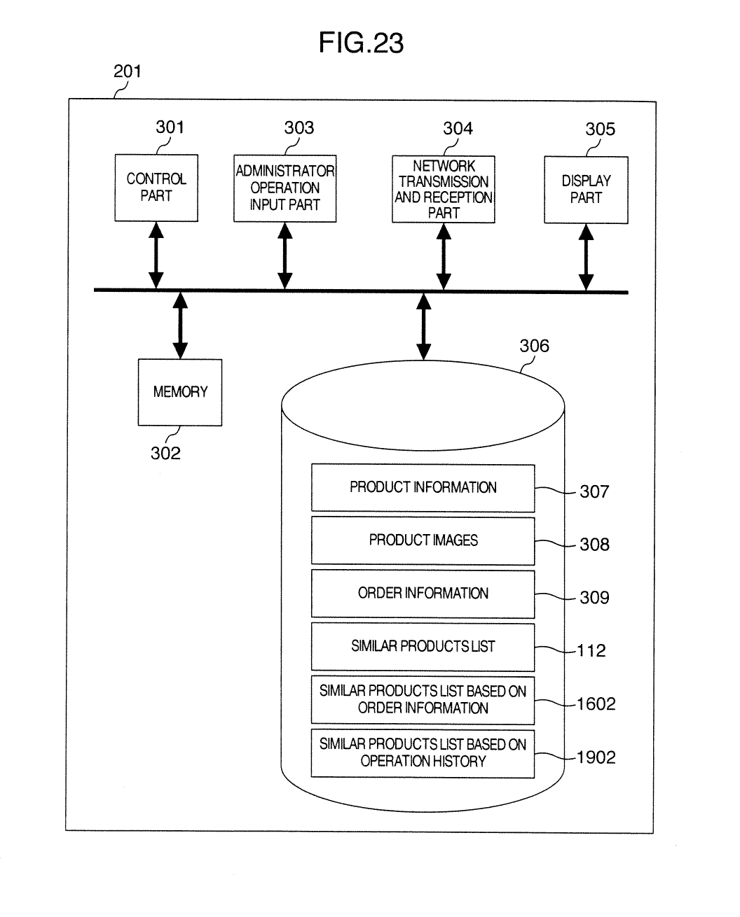

FIG. 23 is a diagram showing an example of a configuration of an order server relating to the present embodiment. In data accumulation part 306 of order server 201, similar products list 112 as well as similar products list (based on order information) 1602 and similar products list, based on operation history, 1902 are accumulated and saved. Similar products list 112, similar products list (based on order information) 1602, and similar products list (based on operation history) 1902 are received and saved, via a network transmission and reception part 304, from product purchase device 101.

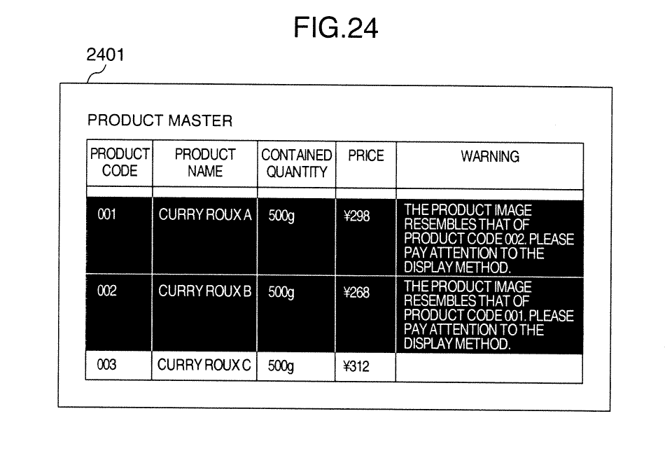

On the occasion that the operator carries out administration of the products, the screen shown in FIG. 24 is displayed and an improvement in the display method is elicited. It is not only in the case where the operator explicitly instructs the display of a screen such as shown in FIG. 24, but it is also acceptable to make the display automatically, with arbitrary timing, such as on the occasion of first displaying an administration screen. Screen 2401 is a screen area presented on a display screen of display part 305 by order server 201. On the occasion of displaying a product master for administering products, an improvement in the product presentation method is elicited from the operator by highlighting, regarding product code 1 and product code 2 registered in similar products list 112, that the same are products which are particularly easy to purchase erroneously. By displaying the reason why a product is judged to be a similar product, an improvement method may be shown even more comprehensibly. Also, there may be elicited an improvement in the product presentation method based on product codes registered not only in similar products list 112 but also in similar products list (based on order information) 1602 and similar products list (based on operation history) 1902.

In the case where product purchase devices 101 exist plurally, it is acceptable to totalize similar products list (based on order information) 1602 and similar products list (based on operation history) 1902 and elicit an improvement in the product presentation method only regarding combinations for which the number of registrations is particularly high.

It should be further understood by those skilled in the art that although the foregoing description has been made on embodiments of the invention, the invention is not limited thereto and various changes and modifications may be made without departing from the spirit of the invention and the scope of the appended claims.

1. A product purchase device, comprising:
a reception part which receives, via a network, information consisting of image information and text information, about a plurality of products;
a display part which displays side by side information about the plurality of products;
an input part inputting an instruction to select one product to be purchased, from the information about the plurality of products displayed by the display part;
a control part which compares information about two products, from the information about the plurality of products, and, on the basis of the fractions of matching information, decides on two products for which there is a possibility of erroneous purchase; and
a storage part which stores the two products decided on by the control part, and wherein the control part makes display with the display part that, in the case where the product selected by the input part is one of the two products stored in the storage part, there is a possibility that, as a product to be purchased, the selected product is erroneous and the other product is correct.

2. The product purchase device according to claim 1,
wherein the control part compares, in information about two products, either image information related shapes or colors, or text information related product names, contained quantities, or prices;
computes the matching fractions; and
determines two products that exceed each of the prescribed threshold values by item of comparison to be two products having a possibility of erroneous purchase.

3. The product purchase device according to claim 1,
wherein the control part compares, in information about two products, either image information related shapes or colors, or text information related product names, contained quantities, or prices:
computes the matching fractions; and,
determines two products for which only the shapes and the colors exceed the prescribed threshold values, two products for which only the product names exceed the prescribed threshold value, or two products for which only the contained quantities and the prices exceed the prescribed threshold values, as two products having a possibility of erroneous purchase, on the basis of each of the threshold values by item of comparison regarding the fractions.

4. A product purchase method, comprising the steps of:
displaying side by side information, consisting of image information and text information, about a plurality of products;
selecting one product to be purchased, from the displayed information about a plurality of products;
comparing information about two products, from the information about the plurality of products, and storing two products having a possibility of erroneous purchase, determined on the basis of the matching fractions of the information; and,
displaying the fact that there is a possibility that the product selected as a product to be purchased is erroneous and the other product is correct in the case where the selected product is one of the two stored products.

5. The product purchase method according to claim 4, wherein the comparing and storing steps comprises the steps of:
comparing, in information about two products, either image information related shapes or colors, or text information related product names, contained quantities, or prices;
computing the matching fractions, and
storing two products that exceed each of the prescribed threshold values by item of comparison as two products having a possibility of erroneous purchase.

6. The product purchase method according to claim 4, wherein the comparing and storing steps comprises the steps of:
comparing, in information about two products, either image information related shapes or colors, or text information related product names, contained quantities, or prices;
computing the matching fractions; and,
storing two products for which only the shapes and the colors exceed the prescribed threshold values, two products for which only the product names exceed the prescribed threshold value, or two products for which only the contained quantities and the prices exceed the prescribed threshold values, as two products having a possibility of erroneous purchase, on the basis of each of the threshold values by item of comparison regarding the fractions.
